(19) United States
(12) Patent Application Publication
(10) Pub. No.: US 2026/0023741 A1
(43) Pub. Date: Jan. 22, 2026

(54) Framework Providing an Agentic Experience on Edge Devices

(71) Applicant: MediaTek Inc., Hsinchu City (TW)

(72) Inventors: Xiaofeng Li, San Jose, CA (US); Chun-Ming Su, Hsinchu City (TW); Rui Zhang, Chengdu (CN)

(21) Appl. No.: 19/211,246

(22) Filed: May 18, 2025

Related U.S. Application Data
(63) Continuation-in-part of application No. PCT/CN2024/106160, filed on Jul. 18, 2024.

(51) Int. Cl. G06F 16/2452; G06F 16/248

(52) U.S. Cl. CPC G06F 16/24522; G06F 16/248

(57) ABSTRACT

A device provides an agentic experience for a user. An agentic manager, which is a management app on the device for providing the agentic experience, receives a request from the user via a user interface. The agentic manager sends a prompt incorporating contextual information of the request to an agentic artificial intelligence (AI) model. The contextual information is retrieved from an on-device database and identifies one or more apps on the device. The agentic manager receives from the agentic AI model an action plan for calling a target app among the one or more of apps. The agentic manager sends action requests according to the action plan to the target app to invoke functionalities of the target app, and sends to the user via the user interface an output that incorporates a response generated by the target app.

### CROSS-REFERENCE TO RELATED APPLICATIONS

This application claims the benefit of PCT Application No. PCT/CN2024/106160 filed on Jul. 18, 2024, the entirety of which is incorporated by reference herein.

### TECHNICAL FIELD

Embodiments of the invention relate to an edge device framework that supports artificial intelligence (AI) agents and interactions between edge devices and cloud services.

### BACKGROUND OF THE INVENTION

Agentic AI systems are designed to operate with autonomy, with the ability to make decisions based on predefined goals and learned experiences. AI agents can utilize a variety of AI models for communicating and collaborating with humans and other AI systems to accomplish tasks. By utilizing diverse AI models, an agentic AI system can perceive its environment, make informed decisions, interact naturally with humans, and perform complex tasks autonomously. Agentic AI systems have the capabilities to function effectively across various domains and applications.

The AI models utilized in an agentic AI system may include machine learning models, deep learning models, natural language processing models, to name a few. Many of these models require a large memory footprint and computation resources. For example, Large Language Models (LLMs) models like GPT-3, GPT-4, and BERT, which are designed for understanding and generating natural language (i.e., human language), enable agentic AI to interact with humans and process textual data. However, an LLM in a server cloud may contain billions of parameters, making it infeasible for an edge device to store a variety of large AI models for diverse purposes. Thus, it is a challenge to provide an agentic AI system on edge devices.

### SUMMARY OF THE INVENTION

In one embodiment, a method provides an agentic experience to a user of a device. The method comprises an agentic manager receiving a request from the user via a user interface. The agentic manager is a management app on the device for providing the agentic experience. The method further comprises the agentic manager sending a prompt incorporating contextual information of the request to an agentic AI model. The contextual information is retrieved from an on-device database and identifies one or more apps on the device. The method further comprises the agentic manager receiving from the agentic AI model an action plan for calling a target app among the one or more of apps, sending action requests according to the action plan to the target app to invoke functionalities of the target app, and sending to the user via the user interface an output that incorporates a response generated by the target app.

In another embodiment, a device is operative to provide an agentic experience to a user. The device comprises one or more processors, and memory to store instructions executable by the one or more processors. The one or more processors are operative to perform the aforementioned method to provide the agentic experience to the user of the device

Other aspects and features will become apparent to those ordinarily skilled in the art upon review of the following description of specific embodiments in conjunction with the accompanying figures.

### BRIEF DESCRIPTION OF DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a block diagram illustrating a device agentic framework architecture according to an embodiment.

FIG. 2 is a flow diagram illustrating a process for installing an app on a device according to one embodiment.

FIG. 3 is a block diagram illustrating models used by an app on a device according to one embodiment.

FIG. 4 is a flow diagram illustrating a method of an agentic framework on a device according to one embodiment.

FIG. 5 is a block diagram illustrating an agentic manager and its interactions with apps on behalf of a user according to one embodiment.

FIG. 6 is a flow diagram illustrating a method performed by an agentic manager to interact with apps on behalf of a user according to one embodiment.

FIG. 7 is a block diagram illustrating a device supporting the service of little assistants according to one embodiment.

FIG. 8 is a flow diagram illustrating a process of activating a little assistant according to one embodiment.

FIG. 9 illustrates an example of little assistant data files according to one embodiment.

FIG. 10 is a flow diagram illustrating a method for providing an agentic experience to a user according to one embodiment.

FIG. 11 is a diagram illustrating a process of token size optimization according to one embodiment.

FIG. 12 is an example of token optimization according to one embodiment.

FIG. 13 is a flow diagram of a method for token size optimization according to one embodiment.

FIG. 14 is a block diagram illustrating the use of feature search to identify a target model for an app according to one embodiment.

FIG. 15 is a block diagram illustrating the use of resource requirements to identify a target model for a prompt according to one embodiment.

FIG. 16 is a diagram illustrating the generation of vector embeddings of app metadata and model metadata according to one embodiment.

FIG. 17 is a flow diagram illustrating a method of a device in collaboration with a cloud according to one embodiment.

FIG. 18 is a block diagram illustrating a device in communication with a cloud according to one embodiment.

### DETAILED DESCRIPTION OF THE INVENTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation. As used herein, the term “and/or” includes any and all combinations of one or more of the associated listed items.

In the following description, the term “agentic manager” refers to a software application that can make autonomous decisions based on available and inferred information, to drive other applications (the “agentic app”) to provide a service. The term “agentic app” (abbreviated as “app”) refers to a software application that can be commanded and/or orchestrated by an agentic manager and take actions to provide services accessible to users, other apps, software, and/or systems. The term “cloud” refers to a remote system of server computers, storage, and software, providing services to edge devices over a network, such as the Internet. The term “edge device” (abbreviated as “device”) refers to a device that is near the edge of a network and provides an entry point to the network. Non-limiting examples of edge devices include smartphones, wearable devices, laptops, personal computers, Internet-of-things (IOTs), navigation devices, infotainment devices, robotic devices, etc. The term “AI model” (abbreviated as “model”) as used herein includes and is not limited to: machine learning models, deep learning models, customized learning models, natural language processing models, large language models (LLM), multi-modal models, neural networks and variations thereof, etc. The term “cloud AI model” or “cloud model” refers to an AI model in the cloud, and “edge AI model” or “edge model” refers to an AI model installed on an edge device.

The disclosure herein describes a device agentic framework that enables an edge device to execute agentic apps and orchestrate the actions of these apps. The device agentic framework includes an agentic manager that uses edge AI models, and/or cloud AI models on demand, to perform AI operations. The agentic apps and agentic manager working together are “agentic” in that they can make autonomous decisions to achieve a given goal, for example, a goal given by a user or by another app or by another device. The autonomous decisions may be based on learned data, metadata, pre-configured data, a combination of these data, etc.

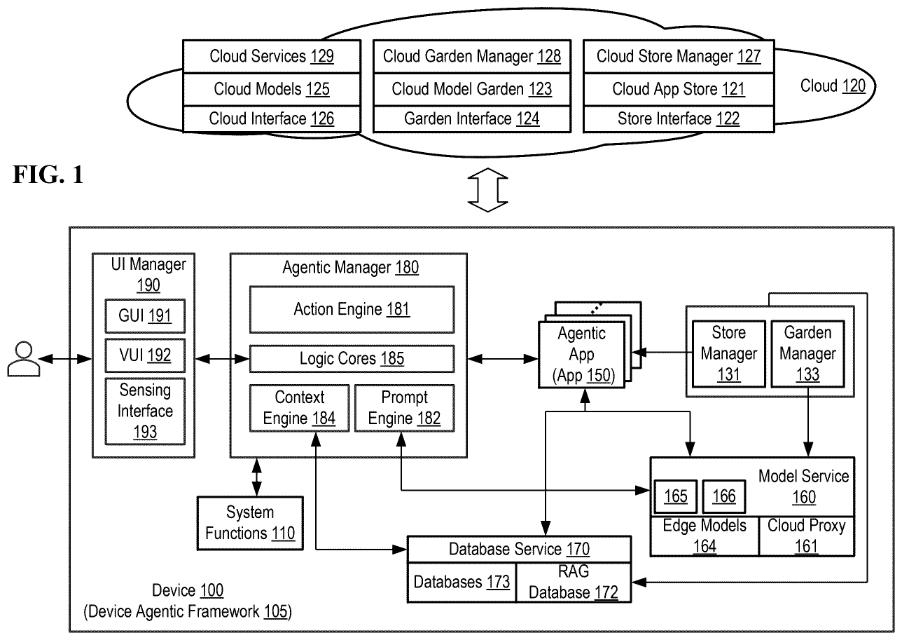

FIG. 1 is a block diagram illustrating a device agentic framework architecture according to an embodiment. In this embodiment, an edge device (e.g., device 100) interacts servers and storage in a cloud 120 via remote access. The cloud 120 is provided by cloud providers, which may include multiple companies across different geographical locations. The cloud 120 supports a wide range of cloud services and provides AI models including downloadable AI models and remotely accessible AI models. In one embodiment, the cloud 120 includes a cloud app store 121 to provide downloadable apps. The cloud app store 121 is managed by a cloud store manager 127 and accessible to the device 100 through a store interface 122. The cloud 120 also includes a cloud model garden 123 to provide downloadable models accessible to the device 100 through a garden interface 124. The downloadable models in the cloud model garden 123 are certified and managed by a cloud garden manager 128. The cloud 120 further provides cloud models 125 and cloud services 129, which are remotely accessible to the device 100 through a cloud interface 126.

The cloud models 125 are available to the device 100 only through remote access. Non-limiting examples for the remote access requirement include the following: the model 125 cannot be deployed on the specific device 100; the model owner does not allow the model 125 to be used on the device 100; the model 125 is too large to fit into the device memory, etc.

The device 100 supports a device agentic framework 105, which includes software code executed by the device 100 to manage agentic apps (“apps 150”), edge models 164, and the interactions with the cloud 120 and users. The device agentic framework 105 includes a store manager 131 and a garden manager 133. The store manager 131 may download one or more apps 150 and the corresponding app metadata to the device 100 from the cloud app store 121. The garden manager 133 may download AI models from the cloud model garden 123. The AI models installed on the device 100 are referred to as edge models 164. AI models may be downloaded and installed on the device 100 according to the metadata of downloaded apps and/or pre-installed apps. The edge models 164 may include base models, low-rank adaptation (LoRa) models, ControlNet models, and other additional models. The edge models 164 are managed by model services 160.

According to embodiments of the invention, when an app 150 requires certain models (e.g., base models and/or LoRa models) to run, the app 150 does not need to be bundled with these models in the download package. The download app package includes the app 150 and the app metadata. The app metadata describes the features of the app 150 and the requirements on the models that the app 150 uses. When the app 150 is downloaded by the store manager 131 on the device 100, the store manager 131 reads the app metadata to determine if the needed models are already available on the device 100. If a needed model is not on the device 100, the garden manager 133 can automatically download the model from the cloud model garden 123.

One advantage of the disclosed framework is that apps and models are decoupled, e.g., models can be downloaded to the device 100 on demand. The models used by the apps 150 on the device 100 can be downloaded from the cloud 120 as needed. In one embodiment, the store manager 131 can automatically download an app and the associated app metadata from the cloud model garden 123 when the app is needed for a given functionality.

The downloaded app metadata may be converted by the database service 170 into vector embeddings and stored in a retrieval augmented generation (RAG) database 172 (also referred to as a vector embedding database or embedding database) to facilitate fast searching. The vector embeddings (also referred to as “embeddings”) are a numerical representation of the semantics of the stored data. An embedding database enables an efficient and accurate search for semantically similar information. Embeddings are usually, but not limited to, high-dimensional vectors encoding semantic contexts and relationships of information. Data stored in the RAG database 172 include but are not limited to: descriptions and features of the apps 150 installed on the device 100, features of the edge models 164, available system functions 110, etc. The device 100 also includes databases 173 that can be searched by keywords or other means. The RAG database 172 and the databases 173 are managed by database service 170.

The device agentic framework 105 further includes an agentic manager 180 (also referred to as an “agentic manager app”), which includes an action engine 181, a prompt engine 182, and a context engine 184, the operations of all of which are coordinated by logic cores 185. The agentic manager 180 interacts with the apps 150, the model service 160, and the database service 170. The agentic manager 180 also interacts with a user via a user interface (UI) manger 190. The agentic manager 180 has access to the edge models 164 and the system functions 110. In one embodiment, the agentic manager 180 is tasked with managing and coordinating the operations of the apps 150.

The device agentic framework 105 provides users with an agentic experience on the edge device 100 using the agentic manager 180 to orchestrate the apps 150 in a user-intuitive way. App developers define app metadata to describe the behaviors and properties of a given app, and upload the app metadata with the given app to the cloud app store 121. The app metadata may be stored in one or more files. A non-limiting example of the file format is JSON. The app metadata may include a feature summary, descriptions of the features, and interface specification of the given app. The interface specification describes what action requests the given app can accept. The app metadata may further specify a specific model for the given app to use, or specify the requirements for a model to be used by the given app. When the given app is downloaded and installed on the device 100, the model service 160 can identify a model for the given app according to the app's requirements. In some embodiments, the app metadata may also describe one or more rules or hints that can be used by the agentic manager 180 to call the given app. When the prompt engine 182 sends a prompt to an edge model 164 to request an action plan for driving a given app, the edge model 164 generates a response describing a sequence of action requests that incorporate the rules or hints. The action engine 181 then sends the sequence of action requests to the given app (which is one of the apps 150) to invoke a given functionality of the given app responding to the user's request.

The cloud model garden 123 maintains model metadata for every certified and downloadable model in the cloud 120. The models in the cloud model garden 123 are certified to run on the device 100. The certification may be provided by the manufacturer or vendor of the device 100, by the manufacturer or vendor of the processors on the device 100 that run the AI models, or other entities holding rights to part or whole of the system stack of the device 100, e.g., the operating system, the device driver, etc. The model metadata describes features of the model, including but not limited to: task type and description, vendor, benchmarks scores, supported input and output data size and type, and power, performance, memory footprint on different hardware platforms. The supported data type described in the model metadata may include one or more of the following: text (of different natural languages, etc.), code (of different programming languages, etc.), image (e.g., emoji, cartoon, plants, etc.), voice (e.g., male, female, etc.), video (e.g., movie, cartoon, documentary, etc.), and other data types. In short, the model metadata describes what the model can accept as well as other information, such as whether the model can receive text or image, the text length limit (e.g., 1000 words or 10 k words), etc.

The device 100 maintains the model metadata of every model it uses (including edge models 164 that are downloaded from the cloud 120 and remotely-accessible cloud models 125). The model metadata may be stored in the databases 173 and/or the RAG database 172. In one embodiment, the model metadata may be stored in the RAG database 172 for vector embedding search (also referred to as “similarity search”) and similarity ranking. Similarity ranking refers to the ranking of the search results according to their similarity to a search criterion, e.g., search for a target model that meets the requirements of an app 150. Any target model (e.g., base models and/or LoRa models; edge models 164 or cloud models 125) meeting the app's requirements can be used by the app 150. The model service 160 may automatically set a target model of the app 150 according to the model requirements indicated in the app metadata. The model service 160 can also determine for an app 150 whether to switch between an edge model 164 and a cloud model 125, between two edge models 164, or between two cloud models 125.

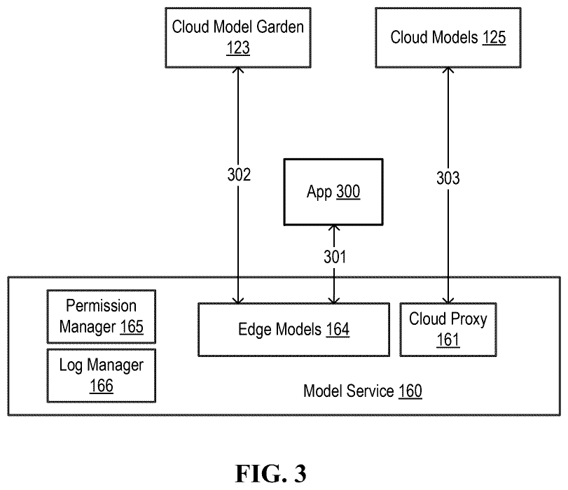

The model service 160 further includes a permission manager 165 and a log manager 166. The model service 160 may interact with the cloud 120 through a cloud proxy 161. A detailed description of the permission manager 165 and the log manager 166 will be provided with reference to FIG. 3.

The UI manager 190 provides various forms of user interfaces for a user to interact with the agentic manager 180. For example, the user interfaces may include a graphical user interface (GUI) 191, a voice user interface (VUI) 192, a sensing interface 193, etc. The GUI 191 may provide graphical icons or links on a display screen for the user to select, and generate graphical outputs for the user to view. The VUI 192 may provide speech-to-text functions (e.g., automatic speech recognition (ASR)) and text-to-speech (TTS) functions to convert user speech input into text, and text output to speech. The sensing interface 193 may include touch sensors to sense users' touch, cameras to detect users' gestures, etc. The agentic manager 180 may utilize one or more edge models 164 for natural language processing, and speech recognition and generation. In one embodiment, the agentic manager 180 may be invoked by a trigger phrase from the user, e.g., “hi there”.

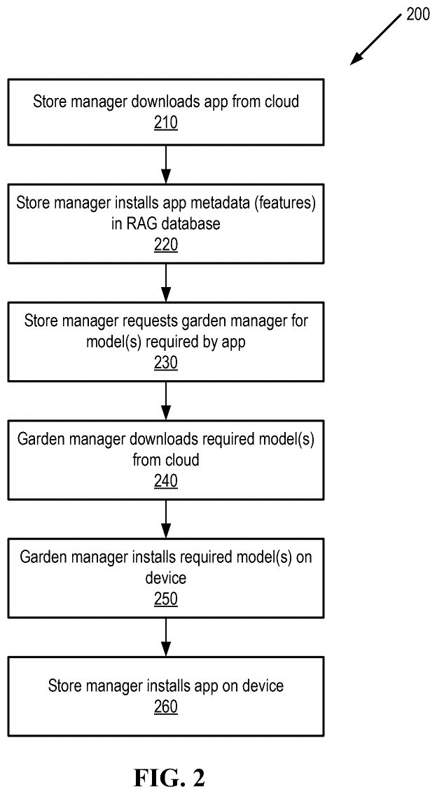

FIG. 2 is a flow diagram illustrating a process 200 for installing an app on an edge device (e.g., device 100) according to one embodiment. Referring also to FIG. 1, the process 200 starts at step 210 when the store manager 131 downloads an app from the cloud 120 to the device 100. The store manager 310 at step 220 installs app metadata describing the features of the app in an on-device database, e.g., the RAG database 172. At step 230, the store manager 131 requests garden manager 133 for model(s) required by the app. At step 240, the garden manager 133 downloads the required model(s) from the cloud model garden 123, if the device 100 does not already have the required model(s). If a required model is already on the device 100, the downloading of the required model can be skipped. At step 250, the garden manager 133 installs the required model(s) on the device 100. At step 260, the store manager 131 installs the app on the device 100.

FIG. 3 is a block diagram illustrating models used by an app 300 on the device 100 according to one embodiment. Referring also to FIG. 1, the app 300 may be any of the apps 150 and the agentic manager 180 (which is a management app). The app 300 may use an edge model 164 (indicated by arrow 301) if the model metadata of that edge model satisfies the requirements indicated in the app metadata. If none of the edge models 164 satisfy the requirement of the app 300, the device 100 may download a model from the cloud model garden 123 (indicated by arrow 302), or finds a remotely-accessible cloud model 125 to satisfy the app's requirement (indicated by arrow 303).

During runtime of the app 300, the model service 160 can switch between an edge model 164 or a cloud model 125 for the app 300 to use, and automatically set the target model for use by the app 300 without disrupting the user experience. The model switching may be based on, for example, the requirements of the app 300 (as indicated in the app metadata or the app's prompts), the capability and constraints of the edge models 164 (as indicated in the model metadata), the user's requests or privacy constraints, etc.

During runtime, the model service 160 may detect a model switching condition, such as model usage exceeding a threshold, device resource consumption exceeding a limit, prompts containing private data, etc., the model service 160 may automatically switch the target model of the app 300 from an edge model 164 to a cloud model 125 or vice versa. The model service 160 may automatically switch the target model of the app 300 from an edge model 164 to another edge model 164. In one embodiment, if the model service 160 switches an edge model 164 to a cloud model 125 for the app 300, the cloud proxy 161 in the model service 160 can redirect the app's prompt to the edge model 164 to the cloud model 125.

Referring to FIG. 1 and FIG. 3, the model service 160 includes the permission manager 165 to authenticate the app 300 and authorize the app 300 to access the edge models 164. One or more of the base models and their associated models (e.g., LoRa models, ControlNet, etc.) on the device 100 may be accessible only to specific apps. For example, a third party who develops a model may authorize those apps from a given company to use that model. The permission manager 165 may check a certification of the app 300 to determine the identity of the app 300, and then determine whether the app 300 is authorized to use that model. The device 100 and/or an edge model 164 can be configured to require the authorization to be automatic or manual. Automatic authorization may be performed by the model service 160 executing an authentication process when the app 300 is invoked to run. Manual authorization may require the user to approve a request from the app 300 to use an edge model 164. According to the model metadata, the authorization process may be specific to an edge model 164, or to a group of edge models 164 meeting a grouping criterion (e.g., from the same vendor or another shared characteristic). For example, the developer of a group of models may provide a certification for an app to use all of the models in the group.

The model service 160 also includes the log manager 166 to provide logging and accounting services for the edge models 164. The log manager 166 may keep track of the usage statistics of each edge model 164. The app 300 may be given a quota for accessing a given edge model 164. The accounting information maintained by the log manager 166 may be used to grant quota-based access for the app 300 to access the given edge model 164. In one scenario, a user may be charged a fee by the app 300 for using an edge model 164 through the app 300. In another scenario, the app 300 may be charged a fee for using an edge model 164. The fee may be collected by the app developer, the model developer, and/or the device vendor, etc. If the app 300 runs out of its quota for one specific edge model, the model service 160 can switch out that edge model to an alternative model that the app 300 has an unused quota or has unlimited access. The model switching may be performed automatically based on a predetermined configuration or runtime determination of similar models. Additionally or alternatively, the user may provide input to the choice of the alternative model. The alternative model may be a cloud model 125 for remote access by the app 300. The alternative model may have lower accuracy and/or longer latency than the original model. The usage statistics include but are not limited to one or more of the following: token size (e.g., the number of input/output tokens processed by the model), execution time (e.g., model usage time), memory usage footprint, etc. In some embodiments, the logging and accounting services for the cloud models 125 may be performed by the cloud services 129 and/or the model service 160, and the usage statistics of the cloud models 125 is accessible to the model service 160.

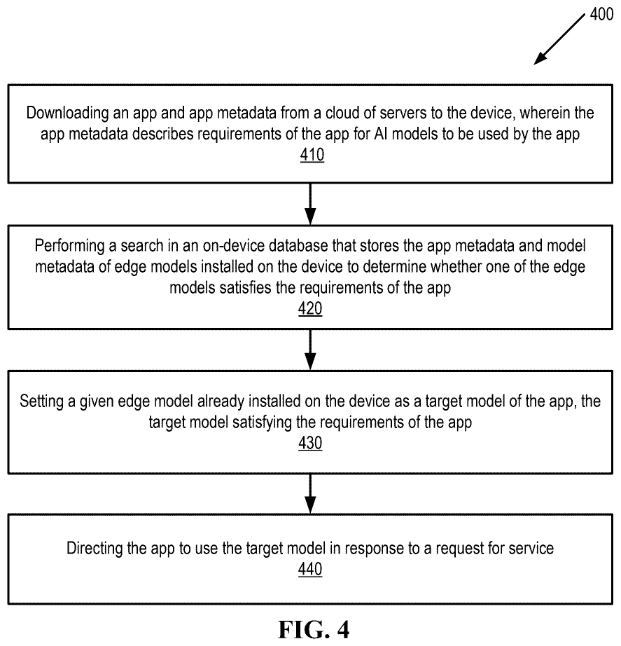

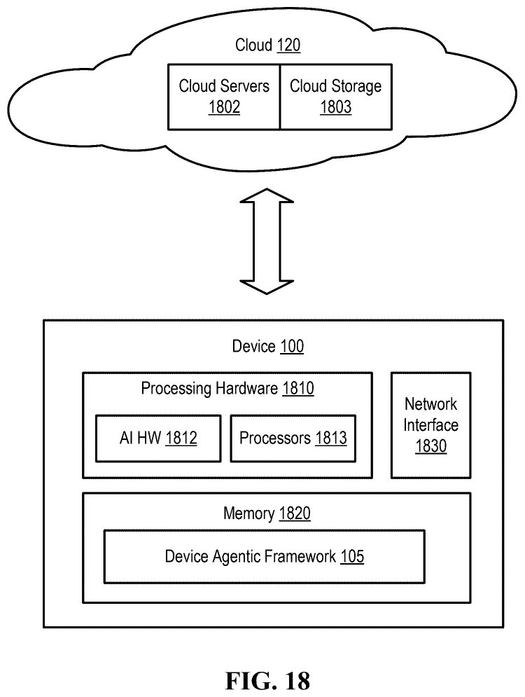

FIG. 4 is a flow diagram illustrating a method 400 of an agentic framework on a device according to one embodiment. The method 400 may be performed by the device 100 of FIG. 1 and FIG. 18. The method 400 begins at step 410 when the device 100 downloads an app and app metadata from a cloud of servers to the device. The app metadata describes requirements of the app for AI models to be used by the app. At step 420, the device 100 performs a search in an on-device database to determine whether one of the edge models installed on the device satisfies the requirements of the app, where the on-device database stores the app metadata and model metadata of the edge models. At step 430, the device 100 sets a given edge model already installed on the device as a target model of the app. The target model satisfies the requirements of the app. At step 430, the device 100 directs the app to use the target model in response to a request for service.

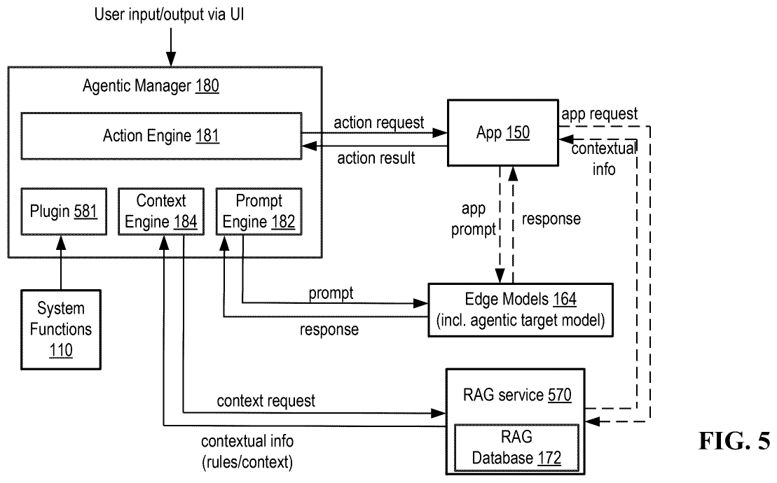

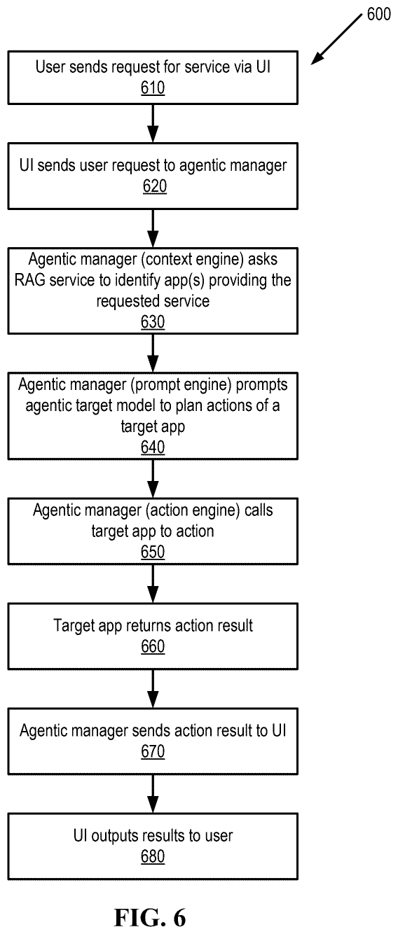

The device agentic framework 105 of FIG. 1 provides an edge device user an agentic experience—an experience of interacting with the on-device apps 150 indirectly through the agentic manager 180. When the interactions among the agentic manager 180, the edge models 164, and the apps 150 are within an edge device, the response latency experienced by a user of the edge device can be minimized. FIG. 5 is a block diagram illustrating the agentic manager 180 and its interactions with apps on behalf of the user according to one embodiment. FIG. 6 is a flow diagram illustrating a method 600 performed by the agentic manager 180 to interact with apps on behalf of the user according to one embodiment. Although the edge models 164 are shown as an example in FIG. 5, it is understood that in some scenarios the cloud models 125 may be used as needed.

Referring to FIG. 1, FIG. 5 and FIG. 6, the method 600 starts at step 610 when a user sends a request for service to the device 100 via the UI manager 190. At step 620, the UI manager 190 sends the user request to the agentic manager 180. At step 630, the agentic manager 180 (more specifically, the context engine 184) sends a context request to a RAG service 570 for contextual information of the user request, such as the identities of one or more apps providing the requested service. The RAG service 570 may be a service provided by the database service 170 of FIG. 1. In one embodiment, the user request may be converted to one or more phrases. The RAG service 570 performs a similarity search in the RAG database 172 based on the similarity between the stored app metadata and the phrases in the user request. In one embodiment, the contextual information generated from the similarity search contains local information and/or user preference information that can be used by the agentic manager 180 to prompt an AI model. This AI model is referred to as the agentic target model or agentic AI model. The agentic target model is typically an edge model 164, but is not required to be an edge model 164. The contextual information can improve the quality and the precision of the response generated by the agentic target model, and, thereby, enhance the user experience. In one embodiment, the contextual information may identify one or more of the apps 150 as target apps to provide the service requested by the user.

At step 640, the agentic manager 180 (more specifically, the prompt engine 182) sends a prompt to the agentic target model, where the prompt includes the contextual information obtained at step 630. In this example, the prompt may include a request for planning app actions. The agentic target model generates a response including an action plan, indicating the action requests that the agentic manager 180 can send to a target app. At step 650, the agentic manager 180 (more specifically, the action engine 181) sends an action request to the target app. At step 660, the target app executes the action and returns an action result to the agentic manager 180. At step 670, the agentic manager 180 sends the action results to the UI manager 190, and at step 680, the UI manager 190 sends an output to the user.

In one embodiment, when the action engine 181 issues an action request to the target app, the prompt engine 182 may send a new prompt to the agentic target model. The issuance of an action request and the new prompt can be concurrent.

The communication between the agentic manager 180 and the apps 150 is bi-directional. The agentic manager 180 requests the target app to take actions, and the target app sends action results to the agentic manager 180. For example, the action may be to order a burger, and the action result may be a list of burgers offered by the food ordering apps on the device 100 or accessible to the device 100. The list may be provided to the agentic manager 180 as an action result, and the agentic manager 180 may consult one or more AI models, online sources, and/or the on-device databases to supplement the list with relevant information (e.g., nutrition and/or price) before generating an output to the user. In some scenarios, the action result from the target app to the agentic manager 180 may be an indication of “success” or “failure” with respect to the food order. Non-limiting examples of the communication methods between the target app and the agentic manager 180 include: shared memory, broadcast, interface language such as AIDL (Android Interface Definition Language), JSON, Android Intent, etc.

In carrying out the action request, the target app may use one or more AI models (e.g., the edge models 164 and/or cloud models 125) to generate the action result. In some scenarios, the target app may generate output without using AI models. Thus, the interactions between the target app, the RAG service 570, and the edge model 164 are shown as dashed lines.

As an example, when a user makes a request to the agentic manager 180, e.g., placing a food order with dietary restrictions, the agentic manager 180 may identify an on-device food ordering app (e.g., the target app) from the RAG search result. The agentic target model may instruct the agentic manager 180 to send action requests to the identified food ordering app. In one embodiment, the food ordering app may use an AI model to find a dish that complies with the user's dietary restrictions. In an alternative embodiment, the agentic manager 180 may use the agentic target model to receive instructions on how to interact with the food ordering app, whereas the food ordering app does not use any AI model to generate action results.

In one embodiment, when the device 100 has not installed any suitable food ordering apps, the agentic manager 180 may trigger the store manager 131 to automatically download an app on demand, such as a food ordering app in this example. The downloaded app can be a mobile app, an instant app, a mini-program, a card, a widget, etc., each of which is a term of art understood by software developers.

Another example of an app using an AI model is as follows. An image editing app may use an AI model to generate an image from text. The agentic manager 180 may issue an action request (e.g., “create an image of a robot”) to the image editing app. The app then accesses its associated AI model to generate an image.

Referring to FIG. 1 and FIG. 5, the device 100 has access to a variety of system functionalities and services (collectively referred to as the system functions 110) such as time, location, device maker information, device ID information such as phone number, device settings such as font size, device control functions such as flight mode, etc., that are not incorporated into the edge models 164. A description of the system functions 110 may be stored in the databases 173 and/or the RAG database 172. The agentic manager 180 can incorporate the system functions 110 into commands when invoking the apps 150 and/or the edge models 164. For example, a request from a user may be “order a burger from the nearest restaurant that is currently open.” The agentic manager 180 can send the request to the RAG service 570, which searches the RAG database 172 to identify contextual information, including one or more food ordering apps and the system functions 110 needed to fulfill the user's request. The agentic manager 180 then calls the system functions 110, such as the location and time service, to obtain the user's location and the current time, and incorporates the location and time information and identifiers of the apps into a prompt to the agentic target model. Based on the inference output of the agent target model, the agentic manager 180 triggers one or more apps 150 to perform actions. In one embodiment, a system function plugin 581 is incorporated into the agentic manager 180 for calling the system functions 110. Non-limiting examples of the plugin implementation include the following: shell code, an interpreter, or an Android application or service, etc.

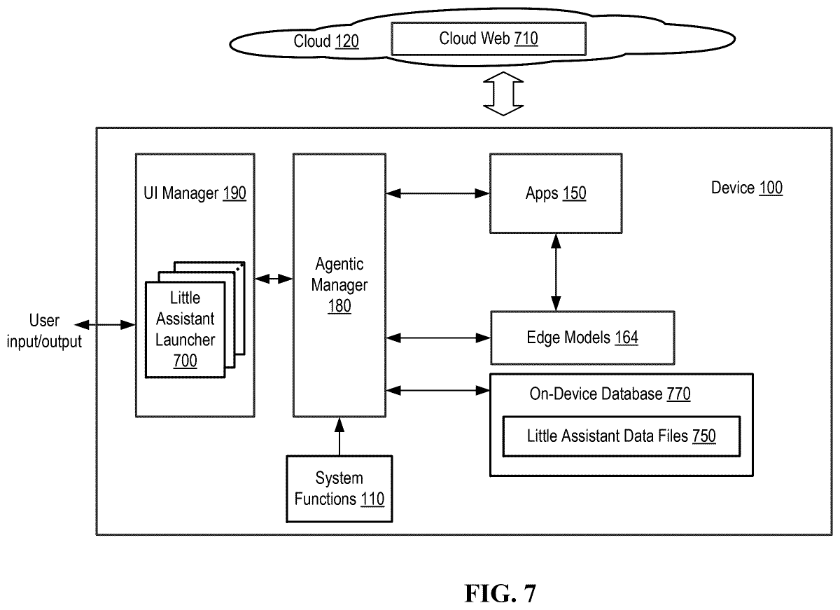

In one embodiment, a user may request for service via a specialized on-device assistant (“little assistant”). FIG. 7 is a block diagram illustrating the device 100 supporting the service of little assistants according to one embodiment. A little assistant can invoke one or more apps 150, the system functions 110, a cloud web 710 (e.g., web-based services and applications in the cloud 120), etc., and can trigger the operations of the agentic manager 180 and/or another little assistant. Each little assistant specializes in tasks that have a specialized purpose. Different little assistants perform different tasks for different purposes. A user may invoke a little assistant to achieve a specific purpose. For example, one little assistant may be a dating assistant, which can tell the user nearby suitable venues that are currently open for a romantic meetup. Another little assistant can identify a fast-food restaurant that currently offers a hamburger special. It is noted that the little assistant is not an app and does not include computer programs for executing a user's requested service. Rather, the little assistant utilizes the agentic manager 180, the system functions 110, and apps (which may be already installed on the device 100 or downloaded to the device 100 on demand) to provide the requested service to the user. From the user's point of view, the user sends a request to a little assistant and receives a response to the request. The background operations of the agentic manager 180, the system functions 110, and the apps involved are hidden to the user.

Suppose that there are three fast-food restaurants of interest to the user, each providing its own online app where its daily specials are posted. A food-ordering little assistant can cause the device 100 to search the daily specials in these restaurant apps, incorporate the system functions 110 of time and location, output the hamburger specials for the user to view and select, and place an order for the user. In one embodiment, a user can invoke a little assistant using a link or an icon on the home screen of the device 100 for quick access by the user. Alternatively, the little assistants can be incorporated into the agentic manager 180 or the apps 150 installed on the device 100. The little assistant may be invoked by the user via the user interface by touch (e.g., tapping or clicking on a link or icon), voice, or another type of command. The UI manager 190 detects the user's command and activates a corresponding little assistant launcher 700. Additionally or alternatively, the little assistant launcher 700 may be activated by an app 150 or by another little assistant on the device 100 and run in the background to provide background service. When a little assistant is activated on the device 100, the little assistant automatically launches the agentic manager 180 to cause the generation of image, text, or speech via user interfaces for user interactions. The agentic manager 180 may call one or more apps 150, the system function 110, and/or cloud services 129 according to little assistant data files 750 in an on-device database 770. In one embodiment, the RAG database 172 (FIG. 1) may be used to store vector embeddings of the little assistant data files 750. The data files 750 are typically compact in size and do not take up much memory space. Incorporating little assistants in an agentic framework can enhance user experience as each little assistant can direct the agentic manager 180 to focus on a specialized task with respect to request and prompt generation, thereby obtaining a response for the user more efficiently.

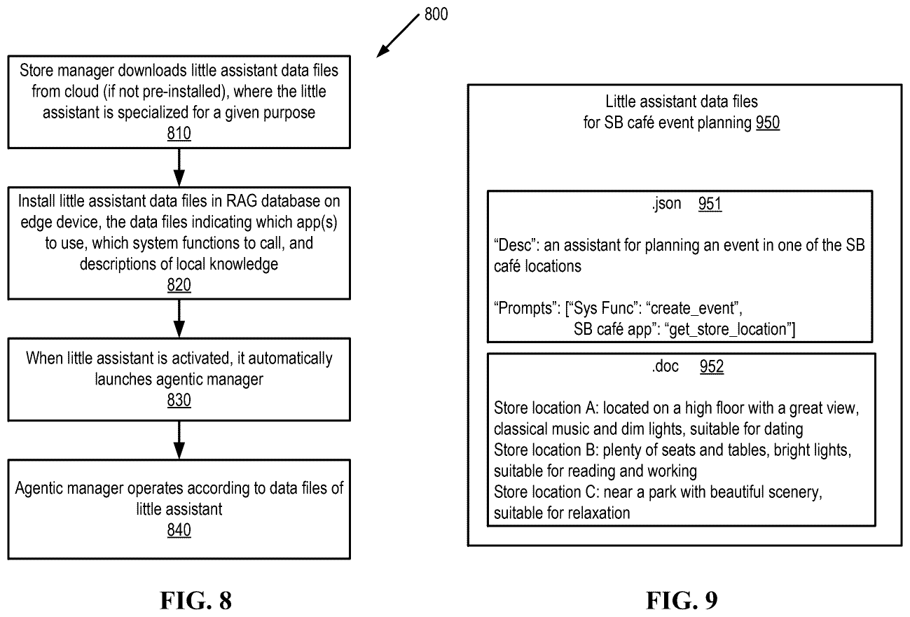

FIG. 8 is a flow diagram illustrating a process 800 of activating a little assistant according to one embodiment. Referring also to FIG. 1, the process 800 starts at step 810 with the store manager 131 downloading the data files 750 of a little assistant from the cloud 120 (if the little assistant has not been installed) to the device 100. The little assistant is specialized for a given purpose. At step 820, the little assistant data files 750 are stored in the on-device database 770, the data files 750 indicating which app(s) to use, which system functions to call, and descriptions of local knowledge. When the little assistant is activated at step 830, the little assistant automatically launches the agentic manager 180. At step 840, the agentic manager 180 performs operations according to the data files 750 of the little assistant. The agent manager 180 may prompt the agentic target model with information obtained from the little assistant data files 750 to receive an action plan. The action plan may direct the agent manager 180 to call one or more apps 150, the system functions 110, and/or the cloud web 710 to generate an output of the little assistant.

In one embodiment, when a request invokes a little assistant, the data files 750 of the little assistant are retrieved from the on-device database 770 such as an RAG database. The data files 750 describes functionalities needed to achieve a task for servicing the request. In one embodiment, the little assistant data files 750 include multiple description files of multiple file formats, e.g., .doc files, JSON files, etc. The contents of these files may be converted into vector embeddings and stored in the RAG database 172. The agentic manager 180 may incorporate the data in the little assistant data files 750 into a prompt to the agentic target model, which then guides the agentic manager 180 to generate requests to invoke needed functionalities, where the functionalities can be provided by the apps 150, by the system functions 110, or by the cloud 120.

In one embodiment, the description files of a little assistant may include an interface description, a description of the little assistant's features for its intended purpose, e.g., a dating assistant that uses the OpenTable online reservation app, a fast-food takeout assistant that uses McDonald app and KFC app, etc. The descriptions may also include the local knowledge of the little assistant in the form of a document or document embeddings. The local knowledge includes supplemental information that is related to its intended purpose and may be of interest to the user, e.g., the local knowledge of a dating assistant may describe the ambience, affordability, and/or crowdedness of the venue, the local knowledge of a fast-food takeout assistant may describe the nutritional value of each food item on the menu. The interface description may include prompts for functionalities needed to achieve a requested task. The agentic manager 180 can follow the interface description to send action requests to one or more apps 150 and system functions 110.

FIG. 9 illustrates an example of little assistant data files 950 according to one embodiment. In this example, the little assistant is an “SB café event planning” assistant. The data files 950 include a .json file 951 and a .doc file 952. The .json file 951 provides an interface description including a description of the purpose of the little assistant (“an assistant for planning an event at one of the SB café locations), and a description of an action sequence, such as the system function (“create_event”) and the app (“SB café app”) to invoke. The .doc file 952 describes the features of each SB café location and what kind of event that location is best suited for. The .doc file 952 information can help the agentic manager 180 and/or the agentic AI model(s) to produce an answer (e.g., identify a location that is best suitable for the user's request).

Using the example in FIG. 9, a user's request may be “I want to meet up with my classmate to study together this weekend.” The output of the agentic manager 180 may be “book a calendar event at SB café location B.” Another example, the user's request may be “I want to relax with my friends over coffee.” The output of the agentic manager 180 may be “book a calendar event at SB café location C.”

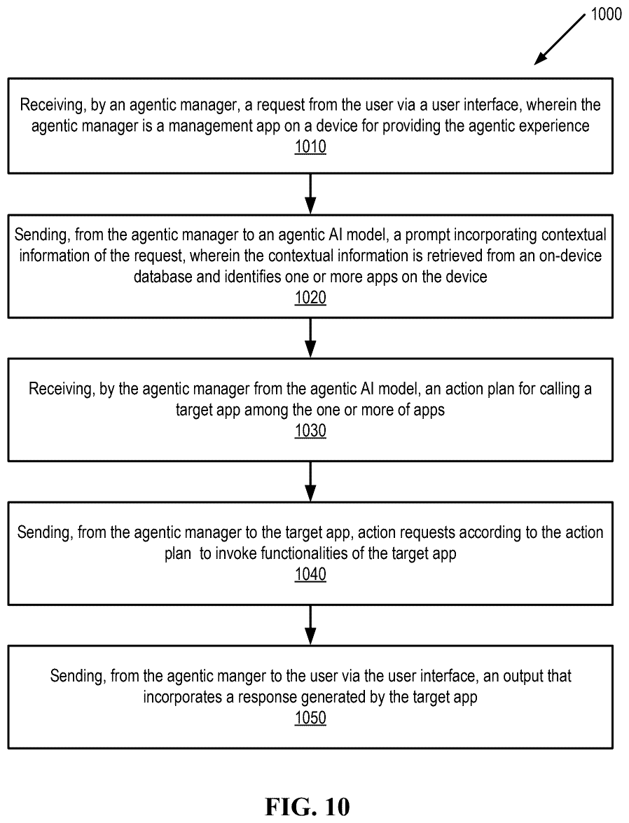

FIG. 10 is a flow diagram illustrating a method 1000 for providing an agentic experience to a user according to one embodiment. The method 1000 may be performed by the device 100 of FIG. 1 and FIG. 18. The method 1000 begins at step 1010 when the agentic manager 180 receives a request from the user via a user interface. The agentic manager 180 is a management app on the device 100 for providing the agentic experience. The agentic manager 180 at step 1020 sends a prompt to an agentic AI model. The prompt incorporates contextual information of the request. The contextual information is retrieved from an on-device database and identifies one or more apps on the device 100. The agentic manager 180 at step 1030 receives from the agentic AI model an action plan for calling a target app among the one or more of apps. The agentic manager 180 at step 1040 sends action requests to the target app according to the action plan to invoke functionalities of the target app. The agentic manager 180 at step 1050 sends to the user via the user interface an output that incorporates a response generated by the target app.

In one embodiment, the agentic manager sends the request to a vector embedding database on the device, the vector embedding database storing app metadata of on-device apps. The agentic manager further identifies the one or more apps based on a similarity search in the vector embedding database between the app metadata and the request. In one embodiment, the app metadata of the target app may be retrieved from a vector embedding database on the device, the app metadata including rules for the agentic manager to call the target app. In one embodiment, the agentic AI model is an LLM on the device.

In one embodiment, a little assistant may be activated on the device. The little assistant is described by data files stored in the on-device database and serves a specialized purpose. In response to activation of the little assistant, the agentic manager is launched to call an app and system functions according to the data files of the little assistant to serve a request. In one embodiment, the data files of the little assistant include an interface description of the app and the system functions for the agentic manager to call, and a document file containing local knowledge for the agentic AI model to produce an answer to the user request. In one embodiment, the agentic manager may further request services from a cloud web according to the data files of the little assistant.

In one embodiment, the agentic manager may call system functions in response to the request from the user to obtain information including at least one of location, time, device maker information, device ID information, device control information, and device settings.

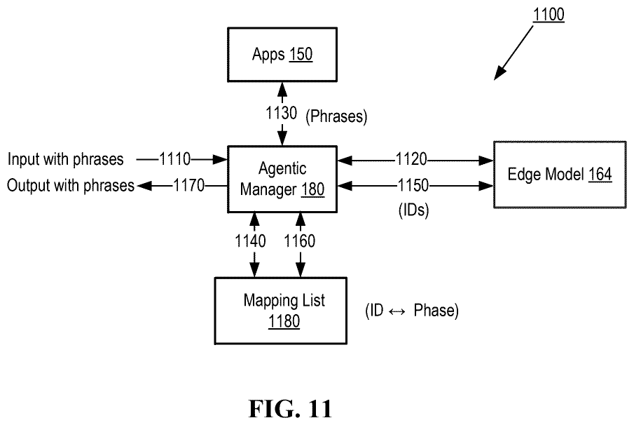

FIG. 11 is a diagram illustrating a process 1100 of token size optimization according to one embodiment. The inference performance of an AI model can be optimized by reducing its token size. With limited on-device computing and storage resources, optimization of inference performance of an edge model 164 can significantly improve user experience. Although the following description is directed to edge models, it is understood that the same optimization can be applied to cloud models.

A prompt received by the edge model 164 is first tokenized into tokens, with each token having a fixed number of bytes. An AI model that processes natural language such as an LLM maps natural language phrases into tokens. A phrase can include a number of words in a natural language such as English, Spanish, Chinese, French, etc., and each phrase is typically tokenized into multiple tokens. In one embodiment, the agentic manager 180 includes a mapping list 1180 that maps the phrases to identifiers and vice versa. The mapping between the phases and the identifiers may be on-to-one. An identifier can be a number, an alphanumeric representation, or another data format. An identifier uniquely identifies a phrase in a prompt and each identifier can be tokenized into a single token. The use of identifiers reduces the number of tokens (i.e., token size) in the model input and output, therefore, improving the model performance.

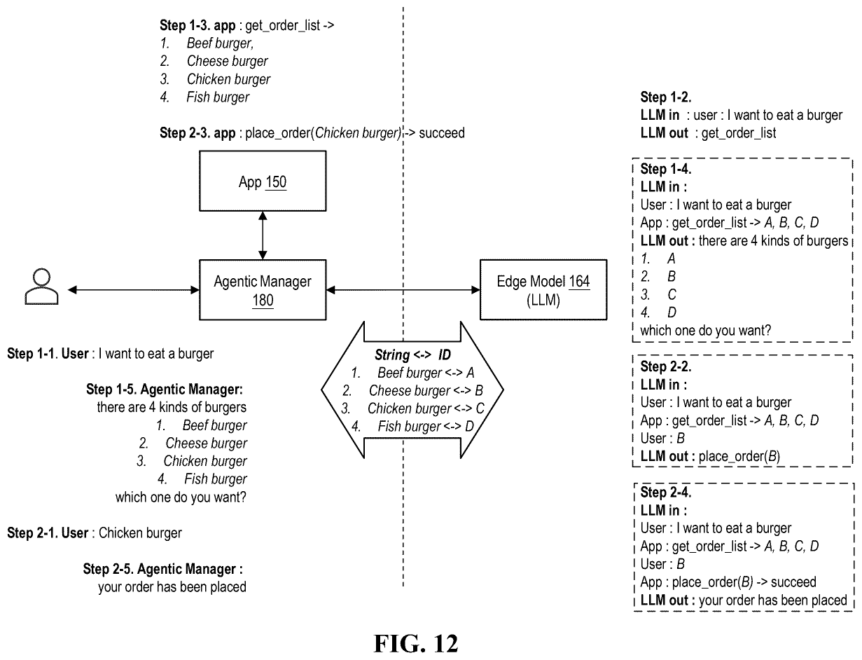

In one embodiment, the agentic manager 180 may replace some or all of the phrases in the textual input and output of the agentic target model (which is an edge model 164) with identifiers. The agentic manager 180 can identify the input phrases that do not impact the action plan output of the edge model 164. In one embodiment, the RAG database 172 (FIG. 1) may store a description of an app's capabilities in the corresponding app metadata. The description may include replaceable phrases in the app's output. The agentic manager 180 can identify these phrases in the app's output based on the app metadata and convert them into the input phrases for the edge model 164. Each of these input phrases can be replaced by a much-shorter identifier that can be represented by a single token. In one scenario, the agentic manager 180 uses the mapping list 1180 to convert some or all of the input phrases to identifiers. The agentic manager 180 then uses the mapping list 1180 to convert all of the identifiers in the output of the edge model 164 to phrases. An example of token optimization is provided in FIG. 12.

In an alternative embodiment where the edge model 164 uses the information contained in the input phrases to generate an action plan (e.g., by performing inference operations), the agentic manager 180 may insert identifiers corresponding to the input phrases before or after the input phrases in a prompt to the edge model 164, and requests the edge model 164 to generate an output in which all of those phrases are replaced by the corresponding identifiers. In this alternative embodiment, the input to the edge model 164 contains both identifiers and phrases, while in the output of the edge model 164, the phrases are replaced by the identifiers. The use of identifiers to reduce token size is more impactful at the output than the input, because the output size of an AI model is typically much larger than the input size. Moreover, the input prompt to the edge model 164 may include instructions, hints, and/or contexts to guide the model's response. Replacing phrases with identifiers can improve the inference performance of AI models.

Referring to FIG. 11, the process 1100 starts with step 1110 when the agentic manager 180 receives an input request containing phrases in a natural language. The agentic manager 180 at step 1120 prompts the edge model 164 for guidance on actions to be taken and receives an action plan in return. The prompt may incorporate contextual information obtained from the on-device database, such as the RAG database. The agentic manager 180 at step 1130 sends action requests to the app 150 and receives an action result that contains phrases. The agentic manager 180 at step 1140 uses the mapping list 1180 to convert the phrases to identifiers. At step 1150 the agentic manager 180 sends a prompt to the edge model 164 containing the identifiers, and receives a response from the edge model 164 that also contains the identifiers. The agentic manager 180 at step 1160 uses the mapping list 1180 to convert the identifiers to phrases, and at step 1170 sends an output containing phrases to the user.

FIG. 12 is an example of token optimization according to one embodiment. The example shows a food ordering process including a first step of selecting a food item and a second step of ordering the selected food item. Each step includes five sub-steps. It is noted that the user needs to know the exact food names to select a food item (step 1-5), and the app needs to know the selected food name to execute an action (step 2-3). Thus, there is no ID replacement for user interaction and app's action. On the other hand, the edge model 164 (e.g., an LLM) does not need to know the food names to determine actions to be taken (step 1-4, step 2-2, and step 2-4, shown in dashed boxes). The food names do not impact the LLM's action plan output as the LLM only copies and then pastes the identifiers from its input (from the agentic manager 180) to its output (to the agentic manager 180). In this example, the app metadata includes a list of food items that are replaceable by identifiers. Thus, the agentic manager 180 can identify that the four options of food items are replaceable by their respective identifier in both the input and output of the LLM in order to reduce the input and output token size of the LLM.

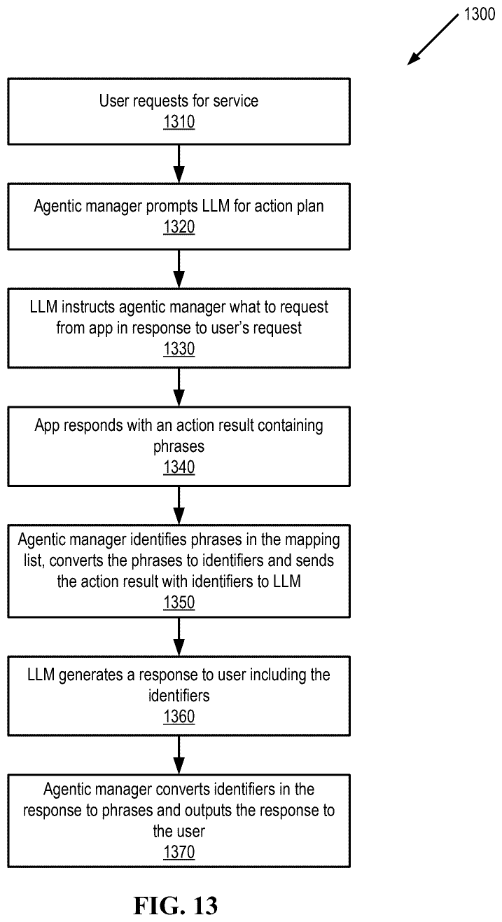

FIG. 13 is a flow diagram of a method 1300 for token size optimization according to one embodiment. The method 1300 may be performed by the device 100 of FIG. 1 and FIG. 18. In one embodiment, the method 1300 begins at step 1310 when the device 100 receives a user's request for service. The agentic manager 180 at step 1320 prompts an LLM for an action plan. The prompt to the LLM may also contain contextual information retrieved from an RAG database. The LLM at step 1330 instructs the agentic manager 180 what to request from an app 150 in response to the user's request. The agentic manager at step 1340 receives from the app 150 an action result containing phrases. The agentic manager 180 at step 1350 identifies the phrases in the mapping list 1180 (FIG. 11), converts the phrases to identifiers, and sends the action result with the identifiers to the LLM. The LLM at step 1360 generates a response to the user, where the response contains the identifiers. The agentic manager 180 at step 1370 converts the identifiers to the corresponding phrases and outputs the response including the phrases to the user.

In one embodiment, the agentic manager may convert phrases of a natural language in a prompt to corresponding identifiers using a mapping list. One or more of the phrases are represented by multiple tokens to be processed by an LLM and each corresponding identifier is represented by one token. The agentic manager sends the prompt containing the corresponding identifiers to the LLM, receives from the LLM an output containing the corresponding identifiers, and converts the corresponding identifiers to the phrases using the mapping list. In one embodiment, the agentic manager may send an action request to an on-device app as directed by the LLM. The agentic manager receives an action result containing the phrases from the on-device app, and identifies the phrases in the mapping list.

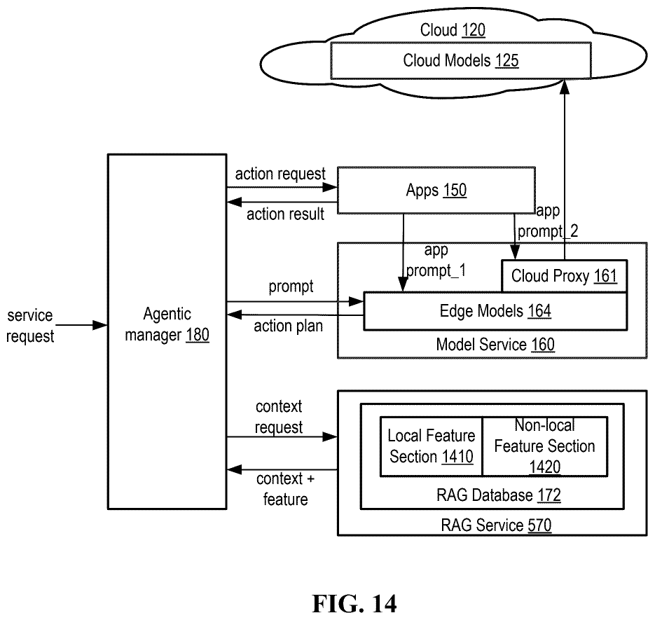

Referring to FIG. 1, in some embodiments, an app 150 can use either an edge model 164 or a cloud model 125 to respond to a service request. The use of the edge models 164 and the cloud models 125 may be interleaved to complete a task without being noticed by the user. FIG. 14 is a block diagram illustrating the use of feature search to identify a target model for an app according to one embodiment. In this embodiment, the criteria for determining the target model (i.e., an edge model 164 or a cloud model 125) is based on a similarity search in the RAG database 172 between the features of the service request and the features of the apps 150. The features of the apps 150 may be indicated in the app metadata stored in the RAG database 172. In one embodiment, the RAG database 172 includes two sections, a local feature section 1410 for local features and a non-local feature section 1420 for non-local features. The local feature section 1410 includes descriptions of local features, which are features that can be served by an edge model 164 or features that should not be served by a cloud model 125. The non-local feature section 1420 includes descriptions of non-local features, which are features that cannot or should not be served by the edge model 164. For example, a local feature description of a given app may be “this is a basic food ordering app for placing a food order.” A non-local feature description of the same given app may be “this food ordering app can place a food order based on your preference, budget, and/or dietary constraints.” The given app is one of the apps 150 installed on the device 100. When a user requests a food ordering service, the service request is sent to the RAG database 172 for feature check. For example, the feature of the service request “ordering food with dietary constraints of peanut allergy” matches the non-local feature of the given app. The agentic manager 180 receives contextual information including the result of feature search from the RAG database 172, and requests the agentic target model (an edge model 164) to provide an action plan. The agentic manager 180 then sends an action request to the given app according to the action plan, indicating that a cloud model 125 is to be used by the given app. Therefore, the prompt from the given app (“app prompt_2”) in this example is directed to the cloud model 125 via the cloud proxy 161. Alternatively, the given app may send the prompt to the cloud model 125 directly. If the service request is “place an order of a BLT sandwich”, the feature of the service request matches the local feature of the given app and the prompt from the given app (“app prompt_1”) will be directed to an edge model 164. In one embodiment, two features are “matched” when a similarity score between the two features exceeds a threshold.

In the RAG similarity search, the prompt features may sometimes match multiple local features and/or non-local features. If the search output returns a matched feature list that includes only local features, an edge model 164 will be used as the target model for the prompt. If the matched feature list includes non-local features only, a cloud model 125 will be used as the target model. If all of the local features in the matched feature list rank higher than all of the non-local features in the matched feature list, the target model is also an edge model 164. On the other hand, if all of the non-local features in the matched feature list rank higher than all of the local features in the matched feature list, the target model is a cloud model 125. In another embodiment, a different model selection algorithm can be used for target model selection. For example, if one of the local features ranks the highest in the RAG similarity search, the target model is an edge model 164. On the other hand, if one of the non-local features ranks the highest, the target model is a cloud model 125.

When the agentic manager 180 decides where (an edge model 164 or a cloud model 125) to send a prompt (e.g., a question), it needs to know which model can answer the question capably, safely, and responsively. Here “capability” means that the model's answer to the question needs to be reasonable and correct. “Safety” means that the prompt does not leak user privacy or secrets. “Responsiveness” means that the model can output a response to the prompt within a predetermined time limit.

Regarding “capability”, some considerations are provided as follows. Local features of an app generally have lower complexity, smaller input/output size, etc. compared to the non-local features. Thus, if a requested service is to generate a 2 Kbyte image from text, the corresponding prompt may be sent to an edge model 164. If the requested service is to generate a 10-megabyte image from text, the corresponding prompt may be sent to a cloud model 125. Moreover, apps may have specialized knowledge in their specialized domains. The local features may describe the specialized domain knowledge of on-device apps that use edge models 164. The non-local features may describe the specialized domain knowledge of on-device apps that use cloud models 125. The same app may have both local and non-local features. Thus, a prompt that requests answers from a specialized domain described in the local features will be sent to an edge model 164, a prompt that requests answers from a specialized domain described in the non-local features will be sent to a cloud model 125.

In one embodiment, the RAG database 172 may store phrases and keywords in the local feature section 1410 and/or the non-local feature section 1420 for use in the similarity search. For example, the non-local feature section 1420 of the RAG database 172 may store the keyword “Galaxy”. Then the RAG similarity search for “how to survive outside the Galaxy?” may return a list of semantically similar results in the order of similarity, e.g., 1. Galaxy (in the non-local feature section 1420), 2. Stars (in the non-local feature section 1420), 3. Starbucks (in the local feature section 1410). According to the search result, a cloud model 125 will be used to respond to the question as the non-local features rank highest among the three results.

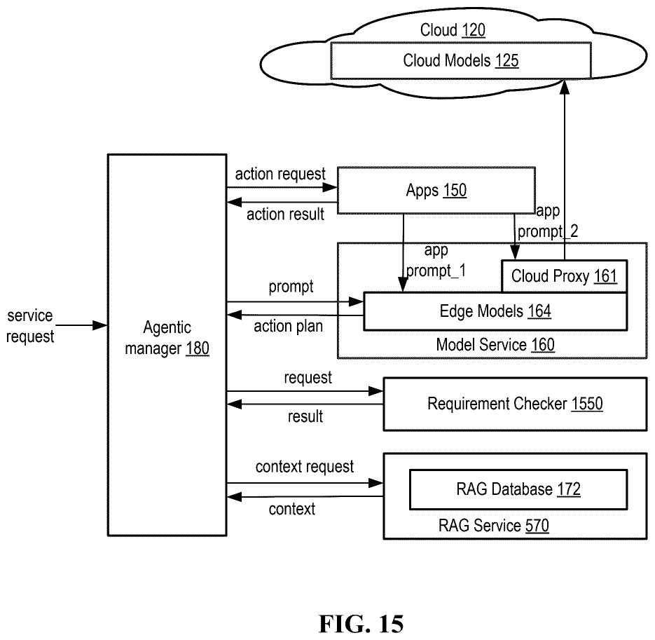

In one embodiment, an app 150 may switch between an edge model and a cloud model based on the responsiveness and/or safety concerns. FIG. 15 is a block diagram illustrating the use of resource requirements to identify a target model for a prompt according to one embodiment. In this embodiment, the criteria for determining the target model of a prompt include the potential resource requirements and/or latency requirements. This requirement check may be implemented as a runtime check by a requirement checker 1550 in the device 100. If the requirement checker 1550 estimates that a prompt is going to cause a large amount (e.g., above a threshold) of resource consumption such as memory footprint or execution time, the prompt (e.g., app prompt_2) is sent to a cloud model 125 via the cloud proxy 161 or directly. If the requirement checker 1550 estimates the resource consumption is within the threshold, the prompt (e.g., app prompt_1) is sent to an edge model 164.

Furthermore, the requirement checker 1550 may determine whether the prompt includes private data that cannot be sent to the cloud 120. If the prompt includes private data (e.g., a personal photo, identity information), the prompt is sent to an edge model 164. In one embodiment, the requirement checker 1550 may determine the resource requirements and latency requirements based on the size and/or complexity of the requested output, or may obtain the model size information by checking the RAG database 172 for the edge model metadata.

In some cases, a user's requests or questions may be answered directly by a model without going through an app. For example, the question “how to survive outside the Galaxy?” may be answered directly by an LLM. A 72 B (i.e., 72 billion parameters) version of an LLM in the cloud 120 may provide a comprehensive answer based on recent scientific discoveries, while a 4 B (i.e., 4 billion parameters) version of the LLM on the edge device 100 may indicate this question being unanswerable. Here, 72 B and 4 B are indications of the size of the LLM. In one embodiment, if the user is not satisfied with the answer provided by the 4 B LLM on the device 100, the user may re-submit the question and the model service 160 directs the question to the 72 B LLM in the cloud 120.

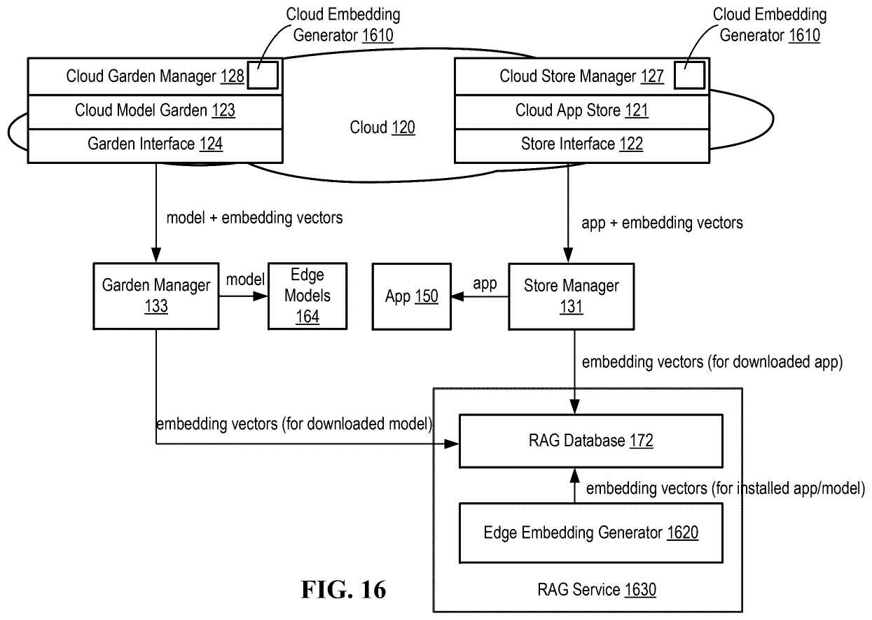

FIG. 16 is a diagram illustrating the generation of vector embeddings of app metadata and model metadata according to one embodiment. Referring to FIG. 1 and FIG. 6, the device 100 stores the app metadata and the model metadata in the RAG database 172 for fast similarity search. The metadata is stored in the form of vector embeddings (also referred to as embeddings). Any additional data needed for running the apps 150 and the edge models 164 can also be stored as vector embeddings in the RAG database 172. In one embodiment, a RAG service 1630 includes an edge embedding generator 1620 to generate embeddings from the app metadata, and store the embeddings in the RAG database 172. Generation of the embeddings can consume a significant amount of computing resources on the device 100. In one embodiment, the cloud store manager 127 includes a cloud embedding generator 1610 to generate embeddings of the app metadata. The cloud embedding generator 1610 can generate the embeddings when an app is uploaded to the cloud app store 121. The cloud embedding generator 1610 can also re-generate the embeddings when an upgraded version of the app is uploaded to the cloud app store 121. The device 100 can download the embeddings whenever needed without consuming the device resources for embedding generation. In some scenarios where an app 150 is installed on the device 100 (e.g., by sideloading instead of downloading from the cloud 120), the embeddings can be generated on the device 100, e.g., by the edge embedding generator 1620.

In one embodiment, the edge embedding generator 1620 may generate embeddings of the model metadata, and store the embeddings in the RAG database 172. In one embodiment, the cloud garden manager 128 may use the cloud embedding generator 1610 to generate embeddings of the model metadata. The cloud embedding generator 1610 can generate the embeddings when a model is uploaded to the cloud model garden 123. The cloud embedding generator 1610 can also re-generate the embeddings when an upgraded version of the model is uploaded to the cloud model garden 123. In some scenarios where an edge model 164 is installed on the device 100 (e.g., by sideloading instead of downloading from the cloud 120), the embeddings can be generated on the device 100, e.g., by the edge embedding generator 1620. The embedding operations performed by the cloud embedding generator 1610 in both the cloud store manager 127 and cloud garden manager 128 are the same as the operations performed by the edge embedding generator 1620.

When an app 150 or an edge model 164 is upgraded; e.g., to a newer version, the device 100 may download the new version with the embeddings of the corresponding metadata if the embeddings are provided. The device 100 can detect the availability of the embeddings from the download. If the embeddings are not available from the download, the edge embedding generator 1620 can generate the embeddings of the upgraded version of the app 150 or the edge model 164 on the device 100.

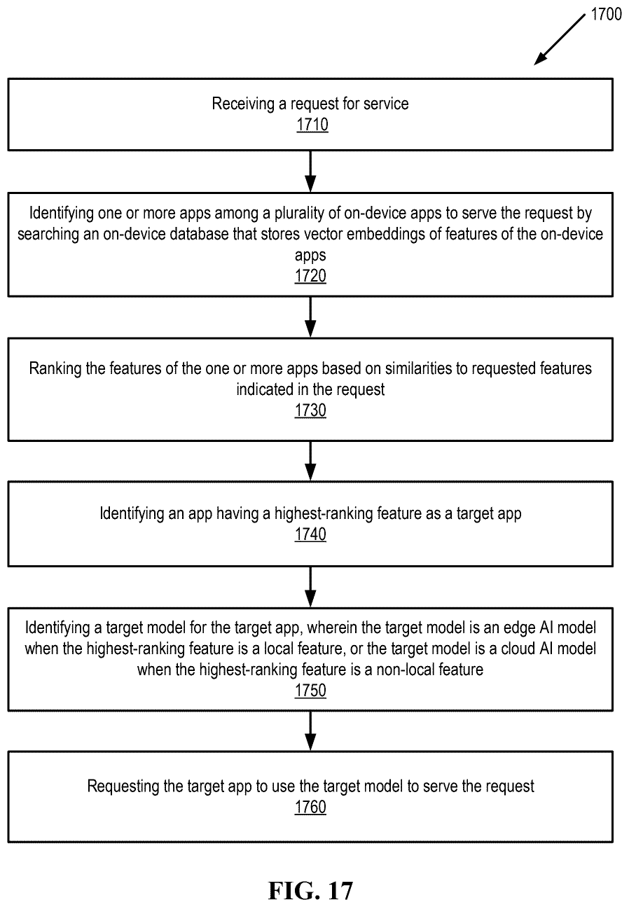

FIG. 17 is a flow diagram illustrating a method 1700 of a device in collaboration with a cloud according to one embodiment. The method 1700 may be performed by the device 100 of FIG. 1 and FIG. 18. The method 1700 begins when the device 100 at step 1710 receives a request for service. The device 100 at step 1720 identifies one or more apps on the device to serve the request by searching an on-device database that stores vector embeddings of features of on-device apps. The device at step 1730 ranks the features of the one or more apps based on similarities to requested features indicated in the request. The device 100 at step 1740 identifies an app having a highest-ranking feature as a target app. The device 100 at step 1750 identifies a target model for the target app. The target model is an edge AI model when the highest-ranking feature is a local feature, or the target model is a cloud AI model when the highest-ranking feature is a non-local feature. The device 100 at step 1760 requests the target app to use the target model to serve the request.

FIG. 18 is a block diagram illustrating the device 100 in communication with the cloud 120 according to one embodiment. Some operations of the device 100 and the cloud 120 have been described with reference to FIG. 1.

The device 100 includes processing hardware 1810, which further includes processors 1813 and AI hardware 1812. Non-limiting examples of the processors 1813 include a central processing unit (CPU), a graphic processing unit (GPU), a digital signal processor, a media processor, etc. The device 100 further includes a memory 1820 such as a static random-access memory (SRAM) device, a dynamic random-access memory (DRAM) device, a flash memory device, and/or other volatile or non-volatile memory devices. The memory 1820 may store the device agentic framework 105 (FIG. 1).

The device 100 may further include a network interface 1830, which may be a wired interface and/or a wireless interface. It is understood that the device 100 is simplified for illustration purposes; additional hardware and software components are not shown.

The cloud 120 includes servers 1802 and storage 1803 to support the operations of the cloud app store 121, the cloud model garden 123, and the cloud models and services 125 in FIG. 1. The cloud 120 and the device 100 are in bi-directional communication via a network, such as the Internet or other types of networks.

The operations of the flow diagrams in this disclosure have been described with reference to the exemplary embodiments of FIG. 1 and FIG. 18. However, it should be understood that the operations of the flow diagrams can be performed by embodiments of the invention other than the embodiments of FIG. 1 and FIG. 18, and the embodiments of FIG. 1 and FIG. 18 can perform operations different than those discussed with reference to the flow diagrams. It is understood that the order of operations shown in the flow diagrams is a non-limiting example. Alternative embodiments may perform the operations in a different order, combine certain operations, overlap certain operations, etc.

Various functional components or blocks have been described herein. As will be appreciated by persons skilled in the art, the functional blocks will preferably be implemented through circuits (either dedicated circuits or general-purpose circuits, which operate under the control of one or more processors and coded instructions), which will typically comprise transistors that are configured in such a way as to control the operation of the circuitry in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for providing an agentic experience to a user of a device, comprising:
receiving, by an agentic manager, a request from the user via a user interface, wherein the agentic manager is a management app on the device for providing the agentic experience;
sending, from the agentic manager to an agentic artificial intelligence (AI) model, a prompt incorporating contextual information of the request, wherein the contextual information is retrieved from an on-device database and identifies one or more apps on the device;
receiving, by the agentic manager from the agentic AI model, an action plan for calling a target app among the one or more of apps;
sending action requests according to the action plan from the agentic manager to the target app to invoke functionalities of the target app; and
sending, from the agentic manger to the user via the user interface, an output that incorporates a response generated by the target app.

2. The method of claim 1, further comprising:
sending the request from the agentic manager to a vector embedding database on the device, the vector embedding database storing app metadata of on-device apps; and
identifying the one or more apps based on a similarity search in the vector embedding database between the app metadata and the request.

3. The method of claim 1, further comprising:
retrieving app metadata of the target app from a vector embedding database on the device, the app metadata including rules for the agentic manager to call the target app.

4. The method of claim 1, wherein the agentic AI model is a large language model (LLM) on the device.

5. The method of claim 1, further comprising:
activating a little assistant on the device, wherein the little assistant is described by data files stored in the on-device database and serves a specialized purpose; and
in response to activation of the little assistant, launching the agentic manager to call an app and system functions according to the data files of the little assistant to serve a request.

6. The method of claim 5, wherein the data files of the little assistant include an interface description of the app and the system functions for the agentic manager to call, and a document file containing local knowledge for the agentic AI model to produce an answer to the user request.

7. The method of claim 5, wherein the agentic manager further requests services from a cloud web according to the data files of the little assistant.

8. The method of claim 1, further comprising:
calling system functions by the agentic manager in response to the request from the user to obtain information including at least one of location, time, device maker information, device ID information, device control information, and device settings.

9. The method of claim 1, further comprising:
converting phrases of a natural language in a prompt to corresponding identifiers using a mapping list, wherein one or more of the phrases are represented by multiple tokens to be processed by a large language model (LLM) and each corresponding identifier is represented by one token;
sending, from the agentic manager, the prompt containing the corresponding identifiers to the LLM;
receiving, by the agentic manager from the LLM, an output containing the corresponding identifiers; and
converting the corresponding identifiers to the phrases using the mapping list.

10. The method of claim 9, further comprising:
sending an action request from the agentic manager to an on-device app as directed by the LLM;
receiving an action result from the on-device app, the action result containing the phrases; and
identifying the phrases in the mapping list.

11. A device operative to provide an agentic experience to a user, comprising:
one or more processors; and
memory to store instructions executable by the one or more processors to:
receive, by an agentic manager, a request from the user via a user interface, wherein the agentic manager is a management app on the device for providing the agentic experience;
send, from the agentic manager to an agentic artificial intelligence (AI) model, a prompt incorporating contextual information of the request, wherein the contextual information is retrieved from an on-device database and identifies one or more apps on the device;
receive, by the agentic manager from the agentic AI model, an action plan for calling a target app among the one or more of apps;
send action requests according to the action plan from the agentic manager to the target app to invoke functionalities of the target app; and
send, from the agentic manger to the user via the user interface, an output that incorporates a response generated by the target app.

12. The device of claim 11, wherein the one or more processors are further operative to:
send the request from the agentic manager to a vector embedding database on the device, the vector embedding database storing app metadata of on-device apps; and
identify the one or more apps based on a similarity search in the vector embedding database between the app metadata and the request.

13. The device of claim 11, wherein the one or more processors are further operative to:
retrieve app metadata of the target app from a vector embedding database on the device, the app metadata including rules for the agentic manager to call the target app.

14. The device of claim 11, wherein the agentic AI model is a large language model (LLM) on the device.

15. The device of claim 11, wherein the one or more processors are further operative to:
activate a little assistant on the device, wherein the little assistant is described by data files stored in the on-device database and serves a specialized purpose; and
in response to activation of the little assistant, launch the agentic manager to call an app and system functions according to the data files of the little assistant to serve a request.

16. The device of claim 15, wherein the data files of the little assistant include an interface description of the app and the system functions for the agentic manager to call, and a document file containing local knowledge for the agentic AI model to produce an answer to the user request.

17. The device of claim 15, wherein the agentic manager further requests services from a cloud web according to the data files of the little assistant.

18. The device of claim 11, wherein the one or more processors are further operative to:
call system functions by the agentic manager in response to the request from the user to obtain information including at least one of location, time, device maker information, device ID information, device control information, and device settings.

19. The device of claim 11, wherein the one or more processors are further operative to:
convert phrases of a natural language in a prompt to corresponding identifiers using a mapping list, wherein one or more of the phrases are represented by multiple tokens to be processed by a large language model (LLM) and each corresponding identifier is represented by one token;
send, from the agentic manager, the prompt containing the corresponding identifiers to the LLM;
receive, by the agentic manager from the LLM, an output containing the corresponding identifiers; and
convert the corresponding identifiers to the phrases using the mapping list.

20. The device of claim 19, wherein the one or more processors are further operative to:
send an action request from the agentic manager to an on-device app as directed by the LLM;
receive an action result from the on-device app, the action result containing the phrases; and
identify the phrases in the mapping list.
